(19) United States
(12) Patent Application Publication
(10) Pub. No.: US 2015/0161062 A1
(43) Pub. Date: Jun. 11, 2015

(54) METHOD, DEVICE AND COMPUTER PROGRAM FOR DYNAMIC CONTROL OF MEMORY ACCESS DISTANCES IN A NUMA TYPE SYSTEM

(71) Applicants: Zoltan Menyhart, Grenoble (FR); Frédéric Temporelli, Echirolles (FR); Benoît Welterlen, Grenoble (FR)

(72) Inventors: Zoltan Menyhart, Grenoble (FR); Frédéric Temporelli, Echirolles (FR); Benoît Welterlen, Grenoble (FR)

(73) Assignee: BULL SAS, Les Clayes Sous Bois (FR)

(21) Appl. No.: 14/403,569

(22) PCT Filed: May 24, 2013
(86) PCT No.: PCT/FR2013/051139

§ 371 Date: Nov. 24, 2014

(30) Foreign Application Priority Data
May 25, 2012 (FR) 1254873

(51) Int. Cl. G06F 13/16; G06F 12/00

(52) U.S. Cl. CPC G06F 13/1657; G06F 12/00; G06F 2212/2542

(57) ABSTRACT

The dynamic monitoring of distances, in particular of memory access distances, in a non-uniform memory access (NUMA) type system comprising a plurality of processors, and a local memory being associated with each processor of the plurality of processors is disclosed. In one aspect, after having obtained at least one NUMA distance between at least one first processor of the plurality of processors and a local memory associated with at least one second processor of the plurality of processors, the at least one NUMA distance obtained is stored in place of at least one NUMA distance, previously stored, between the at least one first processor and the local memory associated with the at least one second processor, the at least one NUMA distance stored being usable directly by the operating system of the NUMA type system.

### CROSS REFERENCE TO RELATED APPLICATIONS

This application is a nationalization of and claims priority to PCT/FR2013/051139, filed on May 24, 2013, which claims benefit of priority to French Application No. 1254873, filed on May 25, 2012, the entirety of which are hereby incorporated by reference.

### BACKGROUND

1. Technological Field

The present application concerns the management of processes in computer systems comprising several processing units and more particularly a method, a device and a computer readable product for dynamic control of memory access distances in a non-uniform memory access system, of NUMA type.

2. Description of the Related Technology

High Performance Computing (HPC) is being developed for university research and industry alike, in particular in technical fields such as the motor car industry, aeronautics, energy, climatology and life sciences. Modeling and simulation make it possible in particular to reduce development costs and to accelerate the placing on the market of innovative products that are more reliable and consume less energy. For research workers, high performance computing has become an indispensable means of investigation.

This computing is generally conducted on data processing systems called clusters. A cluster typically comprises a set of interconnected nodes. Certain nodes are used to perform computing tasks (compute nodes), others to store data (storage nodes) and one or more others manage the cluster (administration nodes). Each node is for example a server implementing an operating system such as Linux (Linux is a trademark). The connection between the nodes is, for example, made using Ethernet communication links and interconnection networks (for example Infiniband) (Ethernet and Infiniband are trademarks).

Typically, each node comprises a processor, working memory and one or more input/output modules. A processor is defined here as a discrete electronic system constituted by one or more processing units, also called cores, that are situated on the same semiconductor substrate. A processor has a memory controller which enables it to access working memory or random access memory which is directly attached to it, generally called local memory. The processor may access that local memory by several memory controllers. Access to the local memory is characterized by very short latency times, typically of the order of 70 ns, and high throughputs, typically of the order of 30 GB/s.

Several nodes may be arranged within the same computer system, for example in the form of a blade, providing specific characteristics, in particular in terms of memory access when several processors each have a local memory.

Exchanges of data between processors belonging to the same computer system may be made by interconnect buses. By way of illustration, the interconnect buses implemented in Intel technology are called Quick Path Interconnect or QPI and the interconnect busses implemented in the AMD technology are called HyperTransport or HT (Intel and AMD are trademarks). These interconnect buses are characterized by high latency times, for example of the order of 140 ns, and a limited bandwidth, for example of the order of 12 GB/s.

For a processor, it is generally faster to access the local memory associated with it than a local memory associated with another processor. To be precise, this last type of access is made via the interconnect bus which often has higher latency times and a more limited throughput than those of the direct links between a processor and an associated local memory. This characteristic of access to the different memories of a computer system, which is non-uniform, is referred to as NUMA (acronym for Non-Uniform Memory Access).

It is possible to define a distance for memory access, or NUMA distance, between a processor and a memory. Such a distance corresponds to a ratio between the latency time for access to the local memory of the processor and the latency time for access to the memory considered. A factor ten multiplier coefficient and rounding are applied to that ratio in order for it to be expressed in the form of an integer.

FIG. 1, comprising Figures la and lb, illustrates an example of a computer system of NUMA type here comprising two processors and four processors respectively.

The computer system 100 illustrated in Figure la comprises a first node 105-1 having a processor referenced 110-1 with which is associated a local memory referenced 115-1. It also comprises a second node 105-2 having a processor referenced 110-2 with which is associated a local memory referenced 115-2. The processors 110-1 and 110-2 are linked by a interconnect bus 120. The latter is bi-directional.

If the latency time of a core of the processor 110-1 to access the local memory 115-1 is equal to a value T1 and if the latency time of the same processor core 110-1 to access the local memory 115-2 is equal to a value T2, the NUMA distance (dist_{NumA}) between the node 105-1 and the node 105-2 is generally defined by the following relationship.

$${dist}_{NUMA} = IP ( \frac{10 \times T 2}{T 1} )$$

where IP represents a function yielding the integer portion of a real number. It is often stated for convenience that this value represents the NUMA distance from the processor 110-1 to the memory 115-2 and also the NUMA distance from the processor 110-1 to the processor 110-2.

The computer system 100′ illustrated in FIG. 1b comprises four nodes referenced 105′-1 to 105′-4, each having a processor 110′-1 to 110′-4, respectively, and a local memory 115′-1 to 115′-4, respectively. As illustrated, each processor is linked to three other processors by a bi-directional interconnect bus. The interconnect buses employed may be identical or different. Thus, for example, the interconnect buses 120′-2, 120′-3 and 120′-4 may be identical. Alternatively, the interconnect buses 120′-2 and 120′-4 may be identical but different from the interconnect bus 120′-3.

The NUMA distances of a computer system may be represented in the form of a square matrix, which is diagonal if each interconnect bus is symmetrical (that is to say if its characteristics are independent of the direction of communication). In this matrix, each row represents a (different) node of the set of nodes of the computer system. Similarly, each column represents a (different) node of the set of nodes of the computer system. Each value of the matrix thus represents the NUMA distance between the processor of the node associated with the row to which belongs the value considered and the memory associated with the node corresponding to the column to which the value considered belongs. The matrix of the NUMA distances of the computer system represented in Figure lb may thus be represented in the following form:

$${dist}_{NUMA} = ( \begin{matrix}{dist}_{NUMA 1 , 1} & {dist}_{NUMA 1 , 2} & {dist}_{NUMA 1 , 3} & {dist}_{NUMA 1 , 4} \\ {dist}_{NUMA 2 , 1} & {dist}_{NUMA 2 , 2} & {dist}_{NUMA 2 , 3} & {dist}_{NUMA 2 , 4} \\ {dist}_{NUMA 3 , 1} & {dist}_{NUMA 3 , 2} & {dist}_{NUMA 3 , 3} & {dist}_{NUMA 3 , 4} \\ {dist}_{NUMA 4 , 1} & {dist}_{NUMA 4 , 2} & {dist}_{NUMA 4 , 3} & {dist}_{NUMA 4 , 4}\end{matrix} )$$

where dist_{NumAi,j} represents the NUMA distance between the processor of the node i and the local memory associated with the node j.

By way of illustration, the values of the NUMA distances of the computer system represented in Figure lb may be the following:

$${dist}_{NUMA} = ( \begin{matrix}10 & 16 & 22 & 22 \\ 16 & 10 & 16 & 22 \\ 22 & 16 & 10 & 16 \\ 22 & 22 & 16 & 10\end{matrix} )$$

The NUMA distances are typically used by the operating system employed in order to optimize the memory allocations, for a program in course of execution on a core, by giving precedence to use of the local memory linked to the processors closest to that core (starting with the local memory of the processor to which that core belongs).

Currently, the NUMA distances between all the processors of the same computer system are determined by the manufacturer of that system. They are stored in a read only memory, typically a memory of EPROM (acronym for Erasable Programmable Read Only Memory) or EEPROM (acronym for Electrically-Erasable Programmable Read-Only Memory) type in accordance with a standardized description called ACPI (standing for Advanced Configuration and Power Interface), forming part of the set of elementary functions called BIOS (acronym for Basic Input/Output System) of the machine considered. More specifically, these distances are defined in a table called SRAT (acronym for Static Resource Affinity Table) which defines the components of each node and a table called SLIT (acronym for System Locality Information Table) which defines the distances between the processors.

Moreover, the current operating systems are based on the ACPI information given by the manufacturer, without providing a means for modifying, if required, the NUMA distances. To meet such a need, a user must make a request a BIOS from the manufacturer of the computer system with specific NUMA distances or develop its own BIOS system, record that new BIOS in the read only memory of the system and lastly restart the system in order for the operating system to be able to take into account the NUMA distances so modified.

Such computer systems do not give full satisfaction. To be precise, the inventors have observed that NUMA distances correspond to theoretical values defined by the processor manufacturers and not, in many cases, to the distances actually determined during phases of development or engineering, nor to reality further to a change in hardware employed, for example the use of processors modifying the behavior of the interconnect bus or having faster access to a local memory.

### Summary Of Certain Inventive Aspects

The application enables at least one of the problems set forth above to be solved.

The application also relates to a method of dynamic control of memory access distances in a non-uniform memory access system implementing an operating system and comprising a plurality of processors, a local memory being associated with each processor of the plurality of processors, this method comprising obtaining at least one memory access distance between at least a first processor of the plurality of processors and a local memory associated with at least one second processor of the plurality of processors and storing the at least one memory access distance obtained in place of at least one memory access distance, stored beforehand, between the at least one first processor and the local memory associated with the at least one second processor, the at least one stored memory access distance being directly usable by the operating system.

The method thus makes it possible to dynamically modify one or more memory access distances, typically one or more NUMA distances, without requiring reprogramming of the elementary functions (BIOS) or a restart of elements of the non-uniform memory access system. In other words, it makes it possible, in particular, to dynamically modify NUMA distances known by an operating system and adapt the behavior of the operating system according to those modifications.

According to a particular embodiment, the method further comprises modifying at least one memory access distance, stored in advance, between the at least one first processor and the local memory associated with the at least one second processor by the at least one memory access distance obtained, in at least one sector or zone of at least one local memory associated with a processor of the plurality of processors. The modification of one or more memory access distances is thus carried out in several phases.

Still according to a particular embodiment, the storing is at least partially implemented by a deferred call function called by a command to write in a predetermined interface of a kernel of the operating system, the predetermined interface of the kernel of the operating system being, preferably, defined in a file system. The method is thus simple to implement and is based on existing mechanisms.

Still according to a particular embodiment, the at least one memory access distance obtained is obtained in string form, the method further comprising a step of parsing the string and of constructing a distance table, the table comprising at least the at least one memory access distance obtained.

The at least one memory access distance stored in advance is advantageously stored in a predetermined structure of the operating system, facilitating the management of those distances and the implementation of the invention.

The obtaining at least one memory access distance and of storing the at least one obtained memory access distance may be initiated by a user, a process executed by the operating system or another system.

The operating system is, for example, an operating system of Linux type.

The application is also directed to a computer program comprising instructions adapted to the implementation of the method described earlier when the program is executed on a computer as well as to a device comprising means adapted to the implementation of that method.

The advantages procured by that computer program and that device are similar to those referred to above.

### BRIEF DESCRIPTION OF THE DRAWINGS

Other advantages and features of the present application will emerge from the following detailed description, given by way of non-limiting example, relative to the accompanying drawings in which:

FIG. 1, comprising Figures la and lb, is a diagram that illustrates an example of a computer system of NUMA type here comprising two processors and four processors, respectively.

FIG. 2 is a flowchart that diagrammatically illustrates certain steps enabling the NUMA distances used by an operating system such as Linux to be modified dynamically.

FIG. 3, comprising FIGS. 3a and 3b, is a diagram that illustrates an example of dynamic modification of NUMA distances in a computer system such as that described with reference to FIG. 1b.

FIG. 4 is a diagram that illustrates a computer system adapted to implement the steps described with reference to FIG. 2.

### DETAILED DESCRIPTION OF CERTAIN ILLUSTRATIVE EMBODIMENTS

The application is generally directed to the dynamic modification of the NUMA distances used by an operating system in a given computer system in order, in particular, to modify the memory allocations and the location of the processes, according to the real configuration of the computer system.

Such modifications of NUMA distances may furthermore be carried out experimentally or in specific contexts.

It is observed here that the modification of the NUMA distances typically requires the updating of the SRAT and SLIT tables and, therefore, necessitates the modification of the read only memory of the computer system, for example the replacement of the EPROM or reprogramming of the EEPROM used, which is a complex operation requiring restarting the operating system in order for the modification to be taken into account.

The SRAT and SLIT tables are read by the operating system employed, at the time of its initialization, and the NUMA distances are copied into a structure in random access memory.

For the Linux operating system (Linux is a trademark), this structure is one of the components of the kernel and is a one-dimensional table of integer values named numa_distance, with a size of [N×N] elements for a system comprising N nodes. The NUMA distance from the node i to the node j is a value located at the location [×N+j] of that table (the values i and j being indexed from 0). The integer values stored in this table are loaded from the ACPI tables of the BIOS, at startup of the operating system, during the initialization of the kernel.

It is noted here that the Linux operating system makes reference to different types of memory, according to considerations of use and physical implementation, implemented by a concept of memory zones per node. By way of illustration, a node has memory zones dedicated to exchanges with peripherals (for example of DMA and DMA32 type, DMA standing for Direct Memory Access), memory zones located in the upper part of the address space (termed HIGH_MEMORY), memory zones capable of being moved in the address space (termed MOVABLE) or for instance a memory zone for normal use (called NORMAL). It is also noted that the Linux operating system uses a memory management system based on pagination (such a mechanism makes it possible, in particular, to implement so-called virtual memory mechanisms).

On initialization of the kernel, the Linux operating system builds, for each node having memory, an independent subsystem for memory management, with its own lists of free pages and used pages, the statistics and locking mechanisms to arbitrate between accesses. Furthermore, for each memory zone, the Linux operating system builds an ordered list of zones termed “zonelist”. A zonelist specifies the zones and nodes to use when the selected zone and node can no longer meet the allocation needs, based on the content of the numa_distance table loaded in advance.

With the kernel of the Linux operating system, without particular modification, it is possible to have read-only access to the values of the NUMA distances table, numa_distance, using the file system sysfs and the command cat, when the operating system implemented is Linux.

It is to be recalled here that the file system sysfs is a virtual file system managed by the operating system and enabling the user, subject to conditions of access privileges, to have available interfaces with that kernel in the form of a tree structure. Thus, via the sysfs file system, the NUMA distances of a node K may be obtained with the following command:

cat/sys/devices/system/node/node<K>/distance

This command displays on a row the distance between the node K and each of the nodes of the system. More globally, it is possible to use the following command:

cat/sys/devices/system/node/*/distance

In this case, the character “*” makes it possible to interrogate the file system sysfs for all the nodes of the system. For each of the nodes, the command then displays the distances relative to each of the nodes of the system. In other words, this command makes it possible to display the table of the NUMA distances of the system.

The command known under the name numactl provides equivalent functionality.

To dynamically modify the NUMA distances in accordance with an embodiment, in a system comprising N nodes, the kernel of the operating system may be modified, in particular, in order to:
benefit from the interfaces of the sysfs file system, which already exist for reading the NUMA distances of a node K, to make writing possible in the entry sysfs/sys/devices/system/node/node<K>/distance and enable the input in string form of the distances between that node K and each node of the system. It is noted here that the modification of the NUMA distances table is made advantageously by successive modifications to the distances for each of the nodes;
create a deferred call function called here “node_write dist” which is called after such writing has been carried out, to modify the NUMA distances of that node K. It is to be recalled here that a deferred call function is a function which is executed by the operating system with the object of processing the information associated with an event after that event has occurred. An example of such a function is given in the Appendix (Code 1);
create a function for string processing here called “node_parse_dist” in order to process the string containing the new NUMA distances for the node K, to obtain those distances in a numerical form, such as a table of distances, each distance being in a numerical integer format which may be directly inserted into the distances table of the kernel. This function is, preferably, called by the function “node_write_dist”;
create a function, here called “numa_set_dist”, to modify the values in the numa_distance structure of the kernel in which are stored the NUMA distances. As parameters, this function uses in particular the coordinates of the NUMA distance to modify (that is to say a node value K as x-coordinate and a node value L as y-coordinate) as well as the new value of that distance. With these parameters, the function can perform the modification of the NUMA distance as defined in the table of NUMA distances used by the operating system. This function is, preferably, called from the function “numa_write_dist”, with the numerical values arising from the call to the function “node_parse_dist”, via a loop on the N nodes of the system, which makes it possible to modify the distance relative to all the nodes of the system for the node K;
adapt the function known under the name “build_all_zonelists” existing in the kernel of the Linux operating system. To be precise, after the modification of the distances from one node to other nodes, the order of the zone lists must be reevaluated to take into account the modified values of the distances. For these purposes, the function “build_all_zonelists”, already used in the kernel of the Linux operating system when creating the lists of zones, on initialization of the operating system or on modifying node components (for example the addition or removal of items from memory) while running (termed hotplug) is called. This function can be advantageously called by the function “node_write_dist” after the new NUMA distances have been recorded in the numa_distance table of the kernel. An example of such a function is given in the Appendix (Code 2); and,
create macros enabling abstractions for non-NUMA architectures, enabling the easy implementation of this functionality with other architectures. To be precise, the Linux operating system may operate on machines not having NUMA functionalities. This set of macros makes it possible to limit the use of the implementation of an embodiment of the invention to architectures able to support it, without perturbing the operation of machines based on other architectures.

Moreover, according to the embodiment of the invention implemented, it may be necessary to define a tool for writing, via the sysfs file system, the NUMA distances in the “distance” attribute of a node or of a set of nodes. A simple tool may be created, for example using a simple script bash, shell or a tool comprising a graphical user interface (GUI). Alternatively, it is possible modify an existing tool, for example the tool numactl.

The tool may also be an automatic system able to adapt the distances written via the file system sysfs according to parameters and using predetermined algorithms. To illustrate simply the command enabling a user to modify the NUMA distances for a node K, it is possible to use basic writing commands provided by the on-line command systems of the operating system used, such as the echo command. It is to be recalled here that the echo command is for writing data to a console peripheral (on-screen display) or, via a directive for redirecting the console stream to a file, for writing data in that file. Thus, the use of this command makes it possible to write the NUMA distances in the NUMA distances attribute for the node considered.

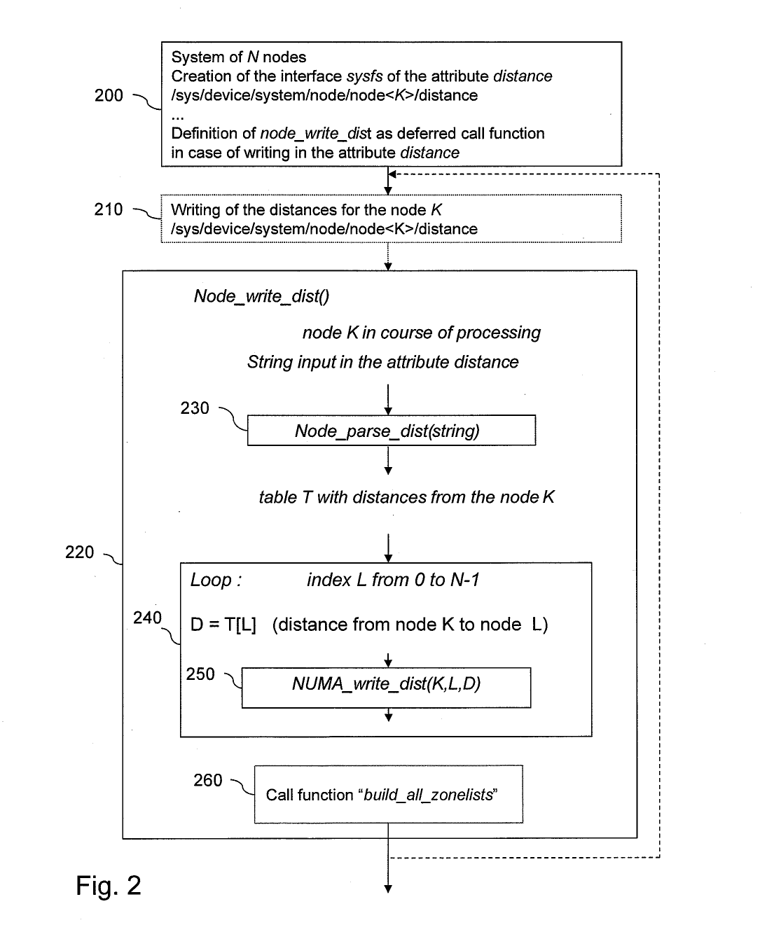

FIG. 2 diagrammatically illustrates certain example steps enabling the NUMA distances used by an operating system such as Linux to be modified dynamically.

As illustrated, a first step (step 200) executed on initialization of the kernel, is directed here to the modification of the attribute “distance” of a node in the interface of the file system sysfs of the kernel, in a system composed of N nodes.

To be precise, in standard manner, the reading of the attribute /sys/devices/system/node/node<i>/distance of the node i (i being indexed from 0 to N-1) uses a deferred call function which performs the display on the console of the NUMA distances for that node i. In accordance with an embodiment, a similar deferred call function is created and gives the possibility of writing that attribute. Such a function can be defined during the initialization of the kernel.

A following step (step 210) here corresponds to the writing of new NUMA distance values, using the sysfs file system, in the attribute distance of the node K, in the form of a string containing the new distances of that node K relative to all the nodes of the system.

Further to the write operation carried out during step 210, the kernel executes the function “node_write_dist” (step 220) with parameters enabling identification of the node K for which the processing is to be carried out as well as the string input in the attribute distance.

As illustrated in FIG. 2, this function calls a function Node_parse_dist(string, table) directed to parsing the string representing new values of NUMA distances into a one-dimensional table, denoted T, of distances for which the origin is the node K and the destination is the set of the N nodes (step 230). Such a parsing function can use a standard algorithm for string parsing. By way of illustration, the distances are represented by numerical values separated by spacing characters in the string.

Further to the transformation of the string into a table T, a loop is performed to update the table numa_distance (step 240). For these purposes, a variable L representing an index on each of the N nodes of the system, varying from 0 to N-1, is used. The variable L is in particular used to obtain the distance D from the node K to the node L in the table T In this same loop, a function denoted numa_write_dist having parameters (index1, index2, distance) is called (step 250) for each pair of nodes indexed by the indices K and L, with the distance D, in order to modify the corresponding item in the numa_distance table, located at the location [K×N+L] by the value D.

Lastly, the function “build_all_zonelists” is called (step 260) to re-order the lists of memory zones of each node in accordance with the new values of distances from the node K.

Thus, for example, the following string “30, 40, 10, 20”, written in the attribute distance of the node 2, is parsed to form the third row of the following table representing the distances matrix for a system,

$$( \begin{matrix}10 & 20 & 30 & 40 \\ 40 & 10 & 20 & 30 \\ 30 & 40 & 10 & 20 \\ 20 & 30 & 40 & 10\end{matrix} )$$

As illustrated by the use of arrows in dashed line, steps 210 to 260 are repeated each time NUMA distances of the computer system considered have to be modified, for example for each of the N nodes of the system.

Furthermore, it is observed that the new NUMA distances may be stored in a file such so as to be able to be loaded in place of the value stored in the SRAT and SLIT tables further to restarting the computer system. Such automatic updating of the NUMA distances on the basis of values stored in a file may be carried out simply using a script launched automatically on start-up of the computer system.

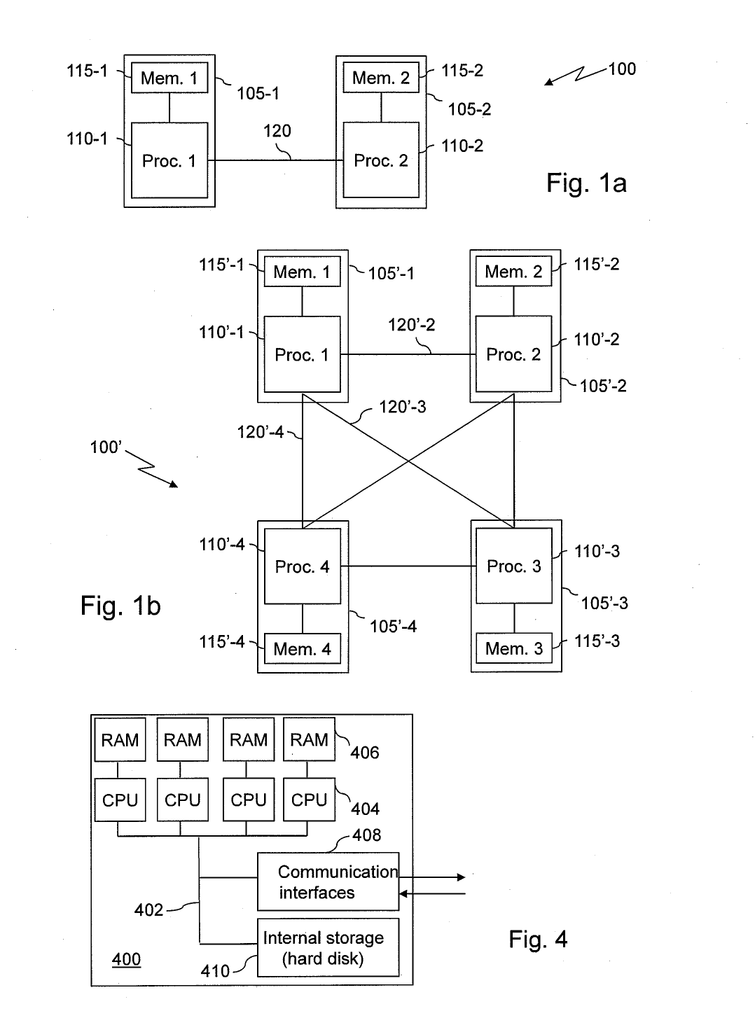

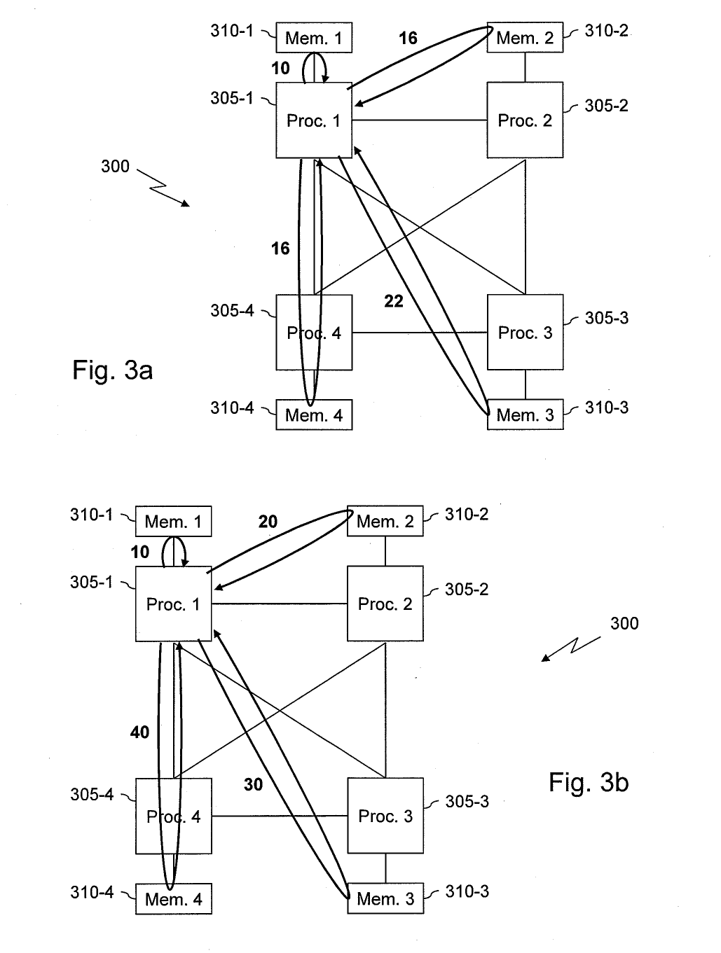

FIG. 3, comprising FIGS. 3a and 3b illustrates an example of dynamic modification of NUMA distances in a computer system such as that described with reference to FIG. 1b. This computer system comprises four processors referenced 305-1 to 305-4 each having a local memory referenced 310-1 to 310-4, respectively, each processor being linked to three others by a bi-directional interconnect bus.

On initialization of the computer system, the NUMA distances are those defined in the SRAT and SLIT tables, for example the values discussed with reference to FIG. 1b:

$${dist ( init )}_{NUMA} = ( \begin{matrix}10 & 16 & 22 & 22 \\ 16 & 10 & 16 & 22 \\ 22 & 16 & 10 & 16 \\ 22 & 22 & 16 & 10\end{matrix} )$$

Thus, for example, as illustrated in FIG. 3a the NUMA distance between the processor 305-1 and the local memory 310-2 associated with the processor 305-2, like the NUMA distance between the processor 305-1 and the local memory 310-4 associated with the processor 305-4, is equal to 16 whereas the NUMA distance between the processor 305-1 and the local memory 310-3 associated with the processor 305-3 is equal to 22.

These distances may be changed without stopping the processors 305-1 to 305-4 and without rebooting the operating system. After having obtained the new NUMA distances to be used, for example after their input by a user, they are stored in the structure used by the operating system to store the NUMA distances, typically the structure distance numa.

These new NUMA distances are for example the following:

$${dist ( new )}_{NUMA} = ( \begin{matrix}10 & 20 & 30 & 40 \\ 40 & 10 & 20 & 30 \\ 30 & 40 & 10 & 20 \\ 20 & 30 & 40 & 10\end{matrix} )$$

After their storage in the structure for the NUMA distances, the NUMA distance between the processor 305-1 and the local memory 310-2 associated with the processor 305-2 is, as illustrated in FIG. 3b, equal to 20, without the operating system having been rebooted. In similar manner, the NUMA distance between the processor 305-1 and the local memory 310-3 associated with the processor 305-3 is equal to 30 and the NUMA distance between the processor 305-1 and the local memory 310-4 associated with the processor 305-4 is equal to 40.

FIG. 4 illustrates an example computer system 400 adapted to implement certain embodiments, in particular the steps described with reference to FIG. 2, here comprising several processors, local memories as well as a communication interface. More specifically, the computer system 400 comprises a communication bus 402, for example an interconnect bus, to which can be connected:
Central Processing Units (CPUs) or processors 404;
components of Random Access Memory (RAM) 406, comprising registers adapted to record variables and parameters created and modified during the execution of programs (as illustrated, each random access memory component is associated with a microprocessor here); and,
communication interfaces 408 adapted to send and to receive data.

The computer system 400 furthermore can possess internal storage means 410, such as hard disks, able in particular to contain the executable code of programs.

The communication bus 402 allows communication and interoperability between the different elements included in the computer system 400 or connected to it. The processors 404 control and direct the execution of the instructions of portions of software code of the program or programs. On powering up, the program or programs which are stored in a non-volatile memory, for example a hard disk, are transferred into the random access memory 406.

Naturally, to satisfy specific needs, a person skilled in the art will be able to apply modifications in the preceding description. In particular, although the invention has been essentially described in the context of an operating system of Linux type, it may be implemented in other environments, for example in an environment using the Microsoft Windows operating system (Microsoft and Windows are trademarks).

```
APPENDIX
static ssiza_t node_write_dist(struct sys_device * dev,
  struct sysdev_attribute *attr, const char *buf, size_t count)
{
  int nid = dev->id;
  int *distances;
  BUILD BUG_ON(MAX NUMNODES * 4 > PAGE SIZE);
  distances = vmalloc(MAX_NUMNODES * sizeof(int));
  node_distance_parse ( buf, distances);
  node_change_distance(nid,distances);
  vfree(distances) ;
  return count;
}
static void node_change_distance(int nid, int* distances)
{
  int i;
  for each_online node(i)
    numa_change_distance (nid, i, distances [i]);
}
          Code 1: node_write_dist
void_ref build_all_zonelists(void *data)
{
  set_zonelist_order( );
  if (system_state == SYSTEM_BOOTING) {
    _build_all_zonelists (NULL);
    mminit_verily_zonelist( );
    cpuset_init_current_mems_allowed( );
  } else {
  /* all cpus are preferably stops to guarantee there is no user of
  zonelist */
#ifdef CONFIG_MEMORY_HOTPLUG
  if (data)
    setup_zone_pageset( (struct zone *)data);#endif
  stop_machine( _ build_all_zonelists, NULL, NULL);
  /* cpu set refresh routine should be here */
  }
  vm_total_pages = nr_free_pagecache_pages( );
  if (vm_total_pages < (pageblock_nr_pages * MIGRATE_TYPES))
    page_group_by_mobility_disabled = 1;
  else
    page_group_by_mobility_disabled = 0;
  printk( “Built %i zonelists in %s order, mobility grouping %s. ”
    “Total pages: %ld\n”,
        nr_online_nodes,
        zonelist_order_name[current_zonelist_order],
        page_group_by_mobilit_disabled ? “off” : “on”,
        vm_total_pages) ;
#ifdef CONFIG_NUMA
  printk( “Policy zone: %s\n”, zone_names [policy_zone]);
#endif
}
    Code 2: build_all_zonelists
19255018
110414
19404991
112414
```

1. A method of dynamic control of memory access distances in a non-uniform memory access system implementing an operating system and comprising a plurality of processors, a local memory being associated with each processor of the plurality of processors, the method comprising obtaining at least one memory access distance between at least a first processor of the plurality of processors and a local memory associated with at least one second processor of said the plurality of processors; and storing the at least one memory access distance obtained in place of at least one memory access distance, stored beforehand, between the at least one first processor and the local memory associated with the at least one second processor, the at least one stored memory access distance being directly usable by the operating system.

2. The method according to claim 1, further comprising modifying at least one memory access distance, stored in advance, between the at least one first processor and the local memory associated with the at least one second processor by the at least one memory access distance obtained, in at least one sector or zone of at least one local memory associated with a processor of the plurality of processors.

3. The method according to claim 1, wherein the storing is at least partially implemented by a deferred call function called by a command to write in a predetermined interface of a kernel of the operating system.

4. The method according to claim 3, wherein the predetermined interface of the kernel of the operating system is defined in a file system.

5. The method according to any one of claims claim 1, wherein the at least one memory access distance obtained is obtained in string form, the method further comprising parsing the string and of constructing a distance table, the table comprising at least the at least one memory access distance obtained.

6. The method according to claim 1, wherein the at least one memory access distance stored in advance is stored in a predetermined structure of the operating system.

7. The method according to claim 1, wherein the obtaining at least one memory access distance and of storing the at least one obtained memory access distance are initiated by a user, a process executed by the operating system or another system.

8. The method according to claim 1, wherein the operating system is an operating system of Linux type.

9. A non-transitory computer readable medium encoded with instructions adapted to direct a computer or processor to carry out the method according to claim 1 when is the instructions are executed on a computer or processor.

10. A device comprising means adapted for the implementation of the method according to claim 1.
